(19) United States
(12) Patent Application Publication
(10) Pub. No.: US 2025/0008196 A1
(43) Pub. Date: Jan. 2, 2025

(54) AUTOMATED VIDEO CLIP SELECTION FOR INCLUSION IN TARGETED COMMUNICATIONS

(71) Applicant: International Business Machines Corporation, Armonk, NY (US)

(72) Inventors: Mikael Hillborg, Umeå (SE); Shaheer Jamal Syed, Stockholm (SE); Emma Jane Dawson, Eastleigh (GB)

(73) Assignee: International Business Machines Corporation, Armonk, NY (US)

(21) Appl. No.: 18/217,389

(22) Filed: Jun. 30, 2023

(51) Int. Cl. H04N 21/81; H04N 21/234; H04N 21/25

(52) U.S. Cl. CPC H04N 21/812; H04N 21/23418; H04N 21/251

(57) ABSTRACT

A method for identifying video clips for inclusion in a targeted communication is disclosed. In one embodiment, such a method includes receiving video footage comprising multiple clips. The method receives multiple information streams that are associated with the video footage and synchronizes the information streams with the video footage. The method applies weights to the information streams, aggregates the weighted information streams, and identifies peaks therein. Clips are then selected from the video footage that correspond to the peaks for inclusion in a targeted communication. The method analyzes metrics from the targeted communication to provide feedback in order to optimize the weights. In certain embodiments, optimizing the weights leads to selecting different clips for inclusion in the targeted communication. A corresponding system and computer program product are also disclosed.

### BACKGROUND

### Field of the Invention

This invention relates generally to techniques for identifying video clips for use in targeted communications.

### Background of the Invention

In today's fast-paced world, consumers are constantly bombarded with targeted communications (e.g., advertisements, presentations, etc.) of various different types. As a result, it is easy for a targeted communication to be ignored or lost in the clutter. This can be a problem when trying to reach a particular audience. An effective targeted communication will ideally stand out from the clutter and grab the attention of a target audience. Ideally, the targeted communication will be compelling to make the audience pause, pay attention, and/or take action.

Targeted communications such as advertisements or presentations can be designed to accomplish various different goals, such as capture an audiences' attention, build brand awareness, communicate product benefits, drive sales and revenue, create emotional connections, differentiate from competitors, shape brand perception, and the like. Some or all of these factors may contribute to the overall success and growth of a business or other organization.

### SUMMARY

The invention has been developed in response to the present state of the art and, in particular, in response to the problems and needs in the art that have not yet been fully solved by currently available systems and methods. Accordingly, systems and methods have been developed for identifying video clips for use in targeted communications. The features and advantages of the invention will become more fully apparent from the following description and appended claims, or may be learned by practice of the invention as set forth hereinafter.

Consistent with the foregoing, a method for identifying video clips for inclusion in a targeted communication is disclosed. In one embodiment, such a method includes receiving video footage comprising multiple clips. The method receives multiple information streams that are associated with the video footage and synchronizes the information streams with the video footage. The method applies weights to the information streams, aggregates the weighted information streams, and identifies peaks therein. Clips are then selected from the video footage that correspond to the peaks for inclusion in a targeted communication. The method analyzes metrics from the targeted communication to provide feedback in order to optimize the weights. In certain embodiments, optimizing the weights leads to selecting different clips for inclusion in the targeted communication.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one embodiment of a system for identifying video clips for inclusion in a targeted communication;

FIG. 3 is a process flow diagram showing one embodiment of a method for identifying video clips for inclusion in a targeted communication;

FIG. 4 is a high-level diagram showing a first exemplary technique for performing audio slicing;

FIG. 5 is a high-level diagram showing a second exemplary technique for performing audio slicing;

FIG. 6 shows various exemplary information streams, namely an events information stream, social media information stream, speech (i.e., text) information stream, and the sum of the information streams; and

FIG. 7 shows the events information stream, social media information stream, and speech (i.e., text) information stream of FIG. 6 multiplied by some weight.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “video clip identification module 150”) for identifying video clips for inclusion in a targeted communication. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

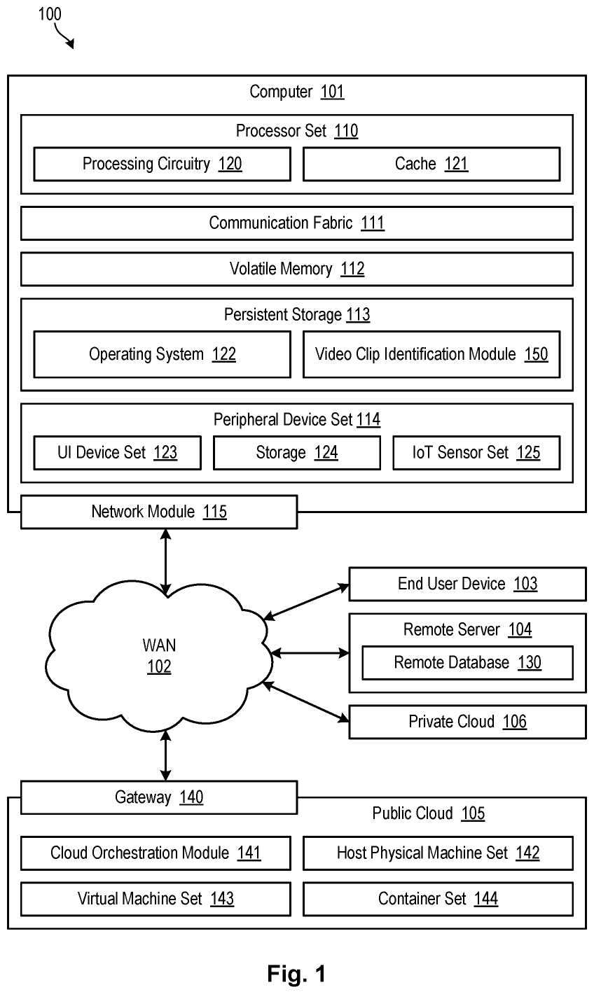

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

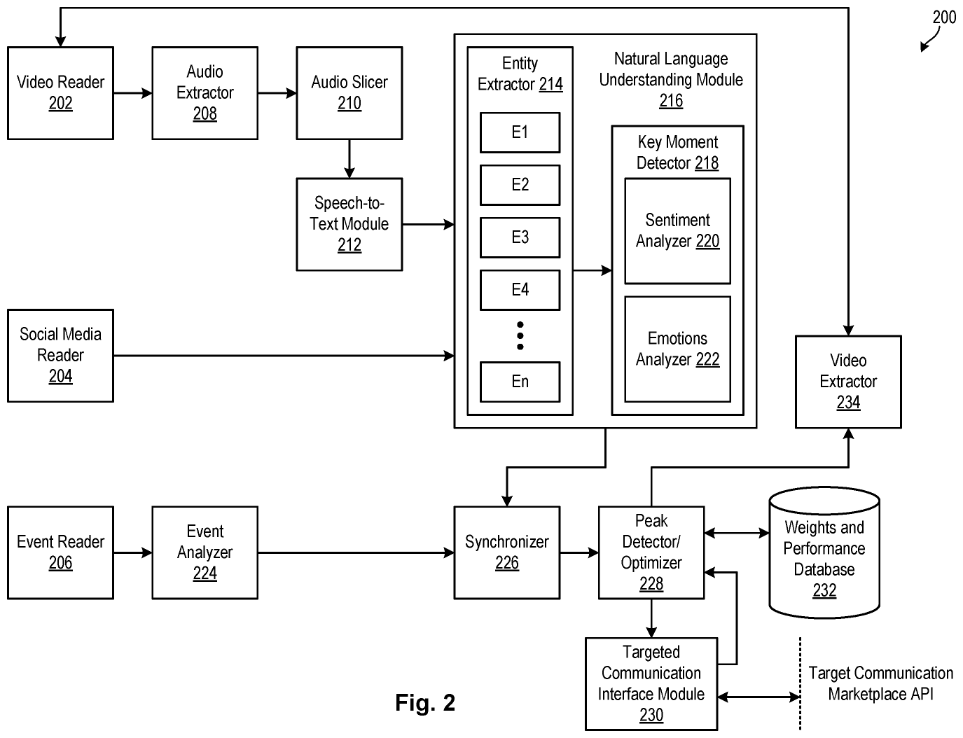

Referring to FIG. 2, in certain cases, selecting a video clip for use in a targeted communication (e.g., an advertisement, presentation, etc.) can be an effective way to showcase key features or benefits of a product, service, or event. Nevertheless, performing such has typically been a cumbersome and time-consuming endeavor. For example, doing so may initially require determining a goal of the targeted communication and the message that will be conveyed in order to identify key features or benefits of a product, service, or event that is to be highlighted. It may then require reviewing a large amount of video footage to select important moments or events. These moments or events may then need to be clipped from the original footage and edited to put them together in a logical and engaging sequence.

Effects and transitions may optionally be added to create a cohesive and polished final product. If desired, text, graphics, and/or audio may be added to the targeted communication to highlight important moments or reinforce key messages. The final product may then be polished to make sure it is properly color-corrected, audio levels are consistent, and any visual effects or transitions are smooth. The final product may then be tested with a focus group or targeted audience and refined based on feedback. Thus, a large number of steps may be needed to select video clips for use in targeted communications.

In certain embodiments in accordance with the invention, a system 200 may be provided that may significantly reduce an amount of work required to select video clips for use in a targeted communication (e.g., advertisement, presentation, etc.). Such a system 200 may be configured to identify clips in a long source video such as a video of an athletic event, video game, movie, television program, performance, theatrical production, concert, or the like. The most effective video clips may then be selected for use in a targeted communication (e.g., an advertisement, presentation, promotional video, trailer, etc.) in order to market a product, service, or future event.

In order to accomplish this, the system 200 may receive various types of inputs or information streams in order to identify clips for use in the targeted communication. For example, the system 200 may receive as inputs the aforementioned source video footage as well as social media streams (e.g., social media posts) and recorded event streams that are associated with the source video footage. The system 200 may include one or more of a video reader 202, social media reader 204, and event reader 206 to receive these inputs.

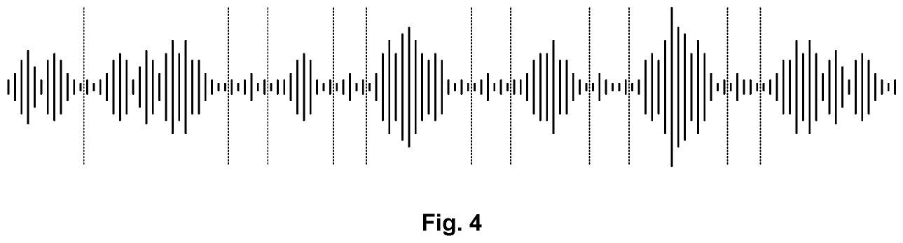

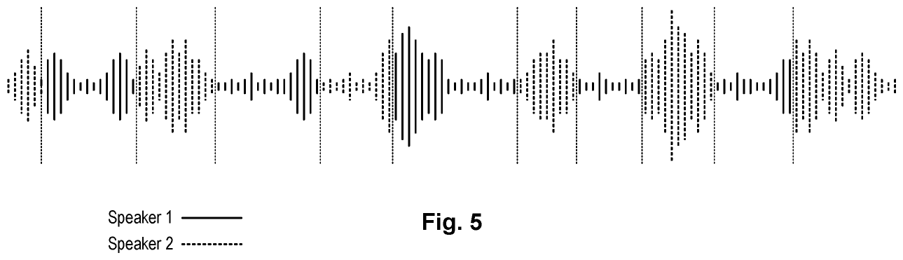

As shown in FIG. 2, when source video footage is received by the video reader 202, an audio extractor 208 extracts audio from the video footage and an audio slicer 210 splits the audio into clips or segments. For example, the audio slicer 210 may look for natural pauses in the audio data and split the audio data at these natural pauses, as shown in FIG. 4, with the dotted vertical lines showing where the audio data may be split. Alternatively, the audio slicer 210 may look for changes in the speaker in the audio data and split the audio data at the points where the speaker changes, as shown in FIG. 5, with the thinner dotted vertical lines showing where the audio data may be split. In certain embodiments, this may be accomplished by converting the audio data to text and then looking for speaker identification fields in the generated text as may be present when using a speech-to-text tool such as Watson speech-to-text. The audio data may then be split at each location where the speaker changes.

A speech-to-text module 212 may convert the audio (e.g., speech) in the clips to text. In certain embodiments, the order of operations of the audio slicer 210 and the speech-to-text module 212 may be reversed, such that speech in the audio data is first converted to text, after which the text is sliced into segments using one of the previously described techniques, such as at pauses in the speech or when the speaker changes from one individual to another.

The text may then be passed to a natural language understanding module 216, such as a Watson natural language understanding (NLU) module 216. An entity extractor 214 within the natural language understanding module 216 may identify and extract significant pieces of information from the unstructured text data received from the speech-to-text module 212. These pieces of information, which may be referred to herein as entities, may allow the data to be labelled and sorted into categories such as people, organizations, locations, dates, and the like. The entity extractor 214 may automatically identify and extract these entities from the text data received from the speech-to-text module 212 to enable the natural language understanding module 216 to gain insight into the text data and make decisions based on the acquired insights.

In certain embodiments, the entity extractor 214 calls a key moment detector 218 within the natural language understanding module 216 to identify key emotional events that occur in the text. The key moment detector 218 may accomplish this, for example, using a sentiment analyzer 220, which may identify sentiments in the text, as well as an emotions analyzer 222, which may identify emotions in the text. Emotions may be intense and short-lived experiences that are typically triggered by a specific event or situation whereas sentiments may be more general and long-lasting attitudes or opinions towards a person, thing, or idea. In certain embodiments, key moments that are detected by the key moment detector 218 are events in the text that go beyond traditional sentiments and emotions. This may enable the key moment detector 218 to identify a set of highlights in the text rather than simply sentiments or emotions.

In certain embodiments, the output of the natural language understanding module 216 may be an information stream with a series of peaks, where the peaks indicate the places in the information stream where the natural language understanding module 216 has detected key moments. In certain embodiments, the magnitude of the peak indicates the magnitude of the key moment that was detected in the information stream.

Similarly, the social media reader 204 may read social media posts or other social media content that is associated with the video footage received by the video reader 202. In certain embodiments, the social media reader 204 reads content from a social media provider using a framework/API that enables access to the content, such as the comment fields on social media platforms. For example, if the video footage is an athletic event, such as a football or basketball game, relevant social media posts may include commentary made at different points during the athletic event. This commentary may originate from a single social media account or multiple accounts if there is more than one social media account associated with and/or producing commentary associated with the video footage.

Like the text derived from the video footage, the text from the social media reader 204 may be passed to the natural language understanding module 216 where it may be analyzed in much the same way as the text from the video footage. More specifically, the entity extractor 214 may identify and extract entities from the text data received from the social media reader 204 to enable the natural language understanding module 216 to gain insight into the text data. The key moment detector 218 may then be called to identify key moments that occur in the text. In certain embodiments, the output of the natural language understanding module 216 for the social media content may also be an information stream with peaks that represent key moments in the social media text. The magnitude of the peaks may indicate the scale or size of the key moments in the text data.

Similarly, the event reader 206 may read events associated with the video footage from a database or other source. For example, if the video footage is for an athletic event, the events may represent the progress of the game such as scores or anything else that quantifies some occurrence or happening in the video footage. Events may be read and prioritized by the event analyzer 224 which may identify major events by looking at the scores and more specifically change-point detection in the sense that it may analyze and segment non-stationary signals to locate sudden changes in the scores. In certain embodiments, the output of the event analyzer 224 is also an information stream with peaks that represent these changes and/or their magnitude.

Using timestamps for the information streams of the video footage, social media, and events, a synchronizer 226 may synchronize the information streams (i.e., properly align them in time). A peak detector/optimizer 228 may then apply a weight to each of the information streams that reflects an importance of the information stream in determining effective video clips in the video footage. In certain embodiments, these weights may be pulled from a weights and performance database 232.

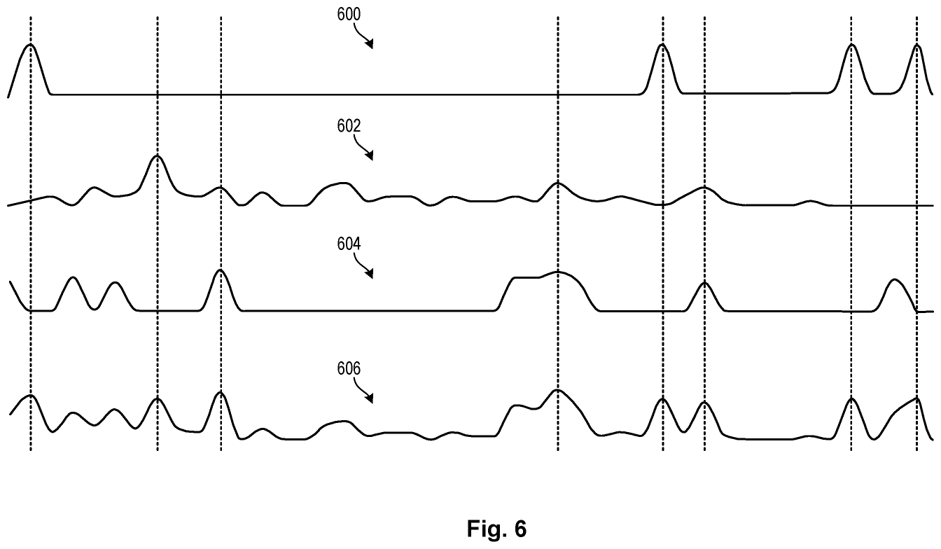

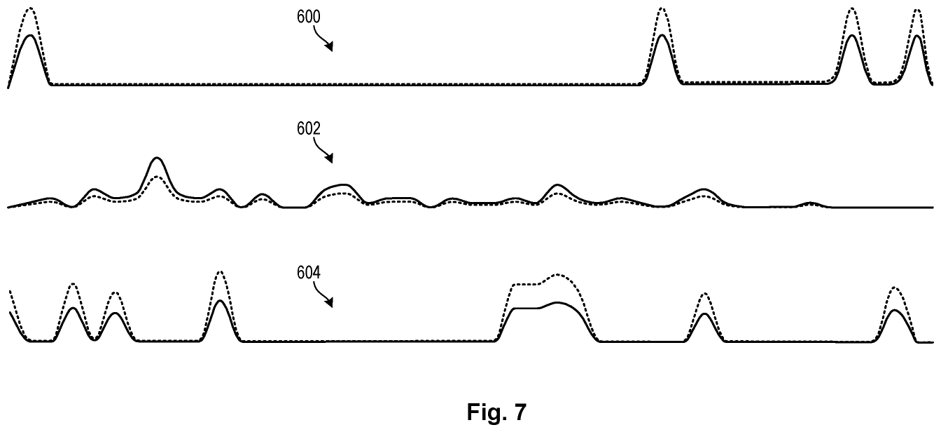

Once the weights are applied to the information streams, the peak detector/optimizer 228 may sum the weighted information streams. As an example, FIG. 6 shows various exemplary information streams, namely an events information stream 600, social media information stream 602, and speech (i.e., text) information stream 604. FIG. 6 also shows the sum 606 of the information streams. FIG. 7 shows the same information streams 600, 602, 604 multiplied by some weight (i.e., the solid line may represent the original information stream whereas the dotted line may represent the information stream after being multiplied by some weight, or vice versa).

Once the information streams 600, 602, 604 are summed, the peak detector/optimizer 228 may determine the peaks in the aggregated information streams with the greatest magnitude. These peaks may be correlated with the clips of the video footage. These clips may be those containing the most effective highlights and thus these clips may be most ideal for inclusion in a targeted communication (e.g., advertisement, presentation, promotional video, trailer, etc.). A targeted communication interface module 230 may interface with a targeted communication marketplace (e.g., an advertising marketplace) to upload a targeted communication thereto. The effectiveness of the targeted communication may be tested in this marketplace. In certain embodiments, performance data (e.g., metrics regarding the effectiveness of a targeted communication, such as view rates, click-through rates, number of impressions or clicks, etc.) may be gathered for the targeted communication and stored in the weights and performance database 232.

The peak detector/optimizer 228 may obtain the performance data from the database 232 and/or targeted communication interface module 230 for use as feedback in optimizing the weights for each of the information streams. The peak detector/optimizer 228 may in certain embodiments use heuristic methods for optimization, such as simulated annealing, particle swarm optimization, solvers, and/or quantum approximate optimization algorithms (QAOA) from quantum computing in order to converge toward optimal weights.

Depending on how the targeted communication performs in the marketplace, the weights may be adjusted in accordance with the heuristic method that is used. In certain cases, the adjusted weights may cause a new clip or clips to be selected for inclusion in the targeted communication. This modified targeted communication may once again be uploaded to and tested in the marketplace. If the modified targeted communication performs better in the marketplace, the peak detector/optimizer 228 may keep the modified targeted communication and its associated weight values. If it performs worse, the peak detector/optimizer 228 may revert to the previous targeted communication (and its associated clip or clips) and to the previous weight values stored in the weights and performance database 232. This process may be repeated until the weights (and the associated clip or clips) ideally converge to an optimal result. In this way, the system 200 may identify the most optimal video clip or clips for inclusion in a targeted communication.

With each iteration, the peak detector/optimizer 228 may record the previous weights in the weights and performance database 232 so that it can remember which weight values were used, and so that it can perform the next iteration using the weight values. Furthermore, the heuristic method may in certain embodiments make random jumps to new weight values, depending on the heuristic method that is used. For example if simulated annealing is used for the heuristic method, then the annealing rate and a few other parameters (depending on distribution etc.) may determine when and how large a random jump should be.

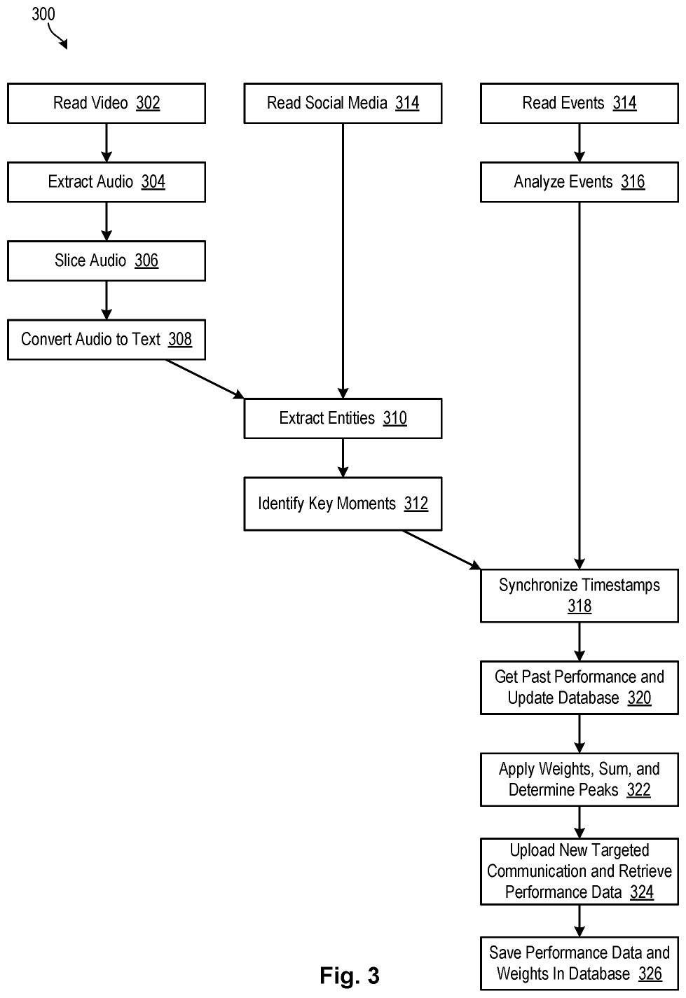

Referring to FIG. 3, a process flow diagram showing one embodiment of a method 300 for identifying video highlights is illustrated. This method 300 may in certain embodiments be executed by the system 200 shown in FIG. 2. As shown, the method 300 initially reads 302 source video footage. The method 300 then extracts 304 audio from the video footage and slices 306 the audio into segments. The method 300 converts 308 the audio (e.g., speech) in the segments into text. The method 300 then identifies and extracts 310 entities from the unstructured text data to gain insight into the text data and make decisions based on the acquired insights. Using the extracted entities, the method 300 identifies 312 key emotional events in the text.

The method 300 also reads 314 social media posts or other social media content that is associated with the video footage. Like the text that is derived from the video footage, the method 300 may analyze the text from the social media in much the same way as the text from the video footage. That is, the method 300 identifies and extracts 310 entities from the text data. Using these entities, the method 300 identifies 312 key moments that occur in the social media text.

Similarly, the method 300 reads 314 events associated with the video footage from a database or other source. The method 300 analyzes 316 these events to identify major events therein.

Using timestamps associated with the video footage, social media, and events previously discussed, the method 300 synchronizes 318 the data (i.e., properly aligns the information streams from the video footage, social media, and events in time). The method 300 further obtains 320 past performance data and updates the performance data and weights in the database 232 previously described. Using the weights, the method 300 applies 322 the appropriate weight to each of the information streams, sums 322 the weighted information streams, and determines 322 the peaks in the aggregated information streams with the greatest magnitudes to identify clips in the video footage to place in a targeted communication. The method 300 may then upload 324 a targeted communication containing the clips to a targeted communication marketplace (e.g., an online advertisement marketplace) where the targeted communication may be tested for its effectiveness. The method 300 may also obtain 324 performance data (e.g., data regarding the effectiveness of the targeted communication from the targeted communication marketplace. The method 300 saves 326 this performance data in the weights and performance database 232 so that the weights can be updated and the targeted communication can be optimized to increase its effectiveness.

Although reference has been made herein to the phrase “targeted communication” as including advertisements, it should be understood that any reference to a targeted communication is not limited to advertisements, and that any such reference thereto is for the purpose of example only. Furthermore, although information streams such as social media streams, recorded event streams, and audio/speech/text streams are used herein to select which video clips are selected for inclusion in a targeted communication, other information streams or parameters may also be used for selecting which video clips are included in a targeted communication. Thus, the disclosed systems and methods are not limited to the disclosed information streams.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for identifying video clips for inclusion in a targeted communication, the method comprising:
receiving video footage comprising a plurality of clips;
receiving a plurality of information streams that are associated with the video footage;
synchronizing the information streams with the video footage;
applying weights to the information streams;
aggregating the weighted information streams and identifying peaks therein;
selecting clips from the video footage that correspond to the peaks for inclusion in a targeted communication; and
analyzing metrics from the targeted communication to provide feedback in order to optimize the weights.

2. The method of claim 1, further comprising recording the weights in a database.

3. The method of claim 1, wherein the targeted communication is an advertisement.

4. The method of claim 3, further comprising testing the advertisement in an advertising marketplace in order to generate the metrics.

5. The method of claim 1, wherein the information streams comprise at least one of social media streams, recorded event streams, and audio streams extracted from the video footage.

6. The method of claim 1, wherein optimizing the weights comprises using a heuristic method to optimize the weights, the heuristic method selected from the group consisting of simulated annealing, particle swarm optimization, solvers, and quantum approximate optimization algorithms (QAOA).

7. The method of claim 1, wherein optimizing the weights leads to selecting different clips from the video footage for inclusion in the targeted communication.

8. A computer program product for identifying video clips for inclusion in a targeted communication, the computer program product comprising a computer-readable storage medium having computer-usable program code embodied therein, the computer-usable program code configured to perform the following when executed by at least one processor:
receive video footage comprising a plurality of clips;
receive a plurality of information streams that are associated with the video footage;
synchronize the information streams with the video footage;
apply weights to the information streams;
aggregate the weighted information streams and identify peaks therein;
select clips from the video footage that correspond to the peaks for inclusion in a targeted communication; and
analyze metrics from the targeted communication to provide feedback in order to optimize the weights.

9. The computer program product of claim 8, wherein the computer-usable program code is further configured to record the weights in a database.

10. The computer program product of claim 8, wherein the targeted communication is an advertisement.

11. The computer program product of claim 10, wherein the computer-usable program code is further configured to test the advertisement in an advertising marketplace in order to generate the metrics.

12. The computer program product of claim 8, wherein the information streams comprise at least one of social media streams, recorded event streams, and audio streams extracted from the video footage

13. The computer program product of claim 8, wherein optimizing the weights comprises using a heuristic method to optimize the weights, the heuristic method selected from the group consisting of simulated annealing, particle swarm optimization, solvers, and quantum approximate optimization algorithms (QAOA).

14. The computer program product of claim 8, wherein optimizing the weights leads to selecting different clips from the video footage for inclusion in the targeted communication.

15. A system for identifying video clips for inclusion in a targeted communication, the system comprising:
at least one processor;
at least one memory device operably coupled to the at least one processor and storing instructions for execution on the at least one processor, the instructions causing the at least one processor to:
receive video footage comprising a plurality of clips;
receive a plurality of information streams that are associated with the video footage;
synchronize the information streams with the video footage;
apply weights to the information streams;
aggregate the weighted information streams and identify peaks therein;
select clips from the video footage that correspond to the peaks for inclusion in a targeted communication; and
analyze metrics from the targeted communication to provide feedback in order to optimize the weights.

16. The system of claim 15, wherein the instructions further cause the at least one processor to record the weights in a database.

17. The system of claim 15, wherein the targeted communication is an advertisement.

18. The system of claim 17, wherein the instructions further cause the at least one processor to test the advertisement in an advertising marketplace in order to generate the metrics.

19. The system of claim 15, wherein the information streams comprise at least one of social media streams, recorded event streams, and audio streams extracted from the video footage.

20. The system of claim 15, wherein optimizing the weights leads to selecting different clips from the video footage for inclusion in the targeted communication.
